(19) United States
(12) Patent Application Publication
(10) Pub. No.: US 2010/0294664 A1
(43) Pub. Date: Nov. 25, 2010

(54) Assay for ALS and ALS-like disorders

(76) Inventors: Ira Leonard Goldknopf, The Woodlands, TX (US); Essam Ahmed Sheta, The Woodlands, TX (US); Brian R. Folsom, Chanhassen, MN (US); Stanley H. Appel, Houston, TX (US); Albert A. Yen, Pearland, TX (US); Erica P. Simpson, Pearland, TX (US)

Correspondence Address: Ira L. Goldknopf, 26022 Budde Road, The Woodlands, TX, 77380, US

(21) Appl. No.: 12/804,868

(22) Filed: Jul. 30, 2010

Related U.S. Application Data
(63) Continuation of application No. 11/487,715, filed on Jul. 17, 2006.
(60) Provisional application No. 60/701,460, filed on Jul. 21, 2005.

(51) Int. Cl. G01N 27/26

(52) U.S. Cl. 204/461; 204/456; 204/606; 204/612

(57) ABSTRACT

The invention relates to an assay for discriminating between amyotrophic lateral sclerosis (ALS) patients and patients with ALS-like disorders that express symptoms like ALS. The method is based on the use of 2-dimensional (2D) gel electrophoresis to separate the complex mixture of proteins found in blood serum, the quantitation of a group of identified biomarkers, and the biostatistical analysis of the concentration of the identified biomarkers to differentiate patients having ALS from patients having other ALS-like disorders.

### CROSS REFERENCE TO RELATED APPLICATIONS

This application is a continuation application of and claims priority to U.S. patent application Ser. No. 11/487,715 filed Jul. 17, 2006 and entitled “Assay for ALS and ALS-Like Disorders” by inventors Ira L. Goldknopf, et al. which claims priority to U.S. Provisional Patent application Ser. No. 60/701,460 filed Jul. 21, 2005 and entitled “Assay for ALS and ALS-Like Disorders” by inventors Ira L. Goldknopf, et al.

### BACKGROUND OF THE INVENTION

1. Field of the Invention

The invention relates to a method for discriminating between amyotrophic lateral sclerosis (ALS) patients and patients with ALS-like disorders that express symptoms like ALS. The method is based on the use of 2-dimensional (2D) gel electrophoresis to separate the complex mixture of proteins found in blood serum and the quantitation of a group of identified biomarkers to differentiate patients having ALS from patients having other ALS-like disorders.

2. Description of the Related Art

ALS is a devastating, fatal neurodegenerative disease that causes the progressive loss of the cells in the brain, spinal cord, and motor nerves that control muscle function. It is the third most common neurodegenerative disease in adults, after Alzheimer's disease and Parkinson's disease. Early symptoms of ALS may include arm and leg weakness, stiffness, and slurred speech. The majority of patients die within 3-5 years from the appearance of the first symptom, usually from respiratory muscle failure.

Presently, the diagnosis of ALS is a clinical one. There is no single test that can provide diagnostic certainty. The usual diagnostic process consists of a full medical history, as well as a comprehensive physical and neurological examination. The revised El Escorial Criteria, developed at a Consensus Conference in Spain in 1990, is widely accepted for the diagnosis of ALS (Chaudhuri, K. R., et al. 1995. J. Neurol. Sci. 129 Suppl.: 11-12). This set of criteria combines clinical features and laboratory test results to classify the level of diagnostic certainty into Definite, Probable, Possible, and Suspected.

Since no definitive diagnostic test for ALS is currently available, numerous studies are typically performed to rule out other medical conditions that can mimic the appearance of ALS. This is important because many of the ALS-like conditions have a much more favorable prognosis. A complete evaluation may include an electromyogram (EMG) with nerve conduction studies (NCV), magnetic resonance imaging (MRI) of the brain and spinal cord, lumbar puncture (LP) with analysis of cerebrospinal fluid (CSF), a panel of blood tests, and muscle biopsy. Because the El Escorial criteria set was originally designed for research purposes, some clinicians find them to be somewhat cumbersome (Brooks, B. R. 2000. Amyotroph. Lateral. Scler. Other Motor Neuron Disord. Suppl 1:S79-S81).

From a clinical standpoint, familial ALS and sporadic ALS are indistinguishable (Mulder, D. W., et al. 1986. Neurology 36: 511-517; Juneja, T., et al. 1997. Neurology 48:55-57; Cudkowicz, M. E., et al. 1997. Ann. Neurol. 41: 210-221; Li, T. M., et al. 1988. J. Neurol. Neurosurg. Psychiatry 51: 778-784). In the United States, 90-95% of ALS cases are sporadic (i.e., no family history of ALS). Only 5-10% of ALS cases are familial. In 10-20% of these familial cases, a mutation can be identified in the gene for superoxide dismutase 1 (SOD1), a ubiquitously expressed antioxidant protein (Siddique, T., et al. 1991. N. Engl. J. Med. 324:1381-1384). Over 90 different SOD1 mutations have been reported in different persons with familial ALS. Although tests are available that can detect SOD1 mutations, less than 20% of familial cases will have a SOD1 mutation (Orrell, R. W., et al. 1997. Neurology 48: 746-751; Shaw, C. E., et al. 1998. Ann. Neurol. 43: 390-394). Thus, SOD1 mutations account for less than 2% of all ALS cases. Mutations in other genes have also been linked to small subsets of familial ALS. Clearly, genetic testing will not detect the majority of ALS cases.

In addition, the etiology of ALS remains undefined. It is even unclear what places a person at-risk of getting ALS. It is currently proposed that a combination of genetic susceptibility factors and environmental factors is involved in an increased risk for ALS. Researchers have repeatedly searched for genetic susceptibility factors that affect cellular processes that influence the survival of motor neurons, including excitotoxicity (Rothstein, J. D., et al. 1995. Ann. Neurol. 38(1): 73-84; Rothstein, J. D., et al. 1992. N. Engl. J. Med. 326: 1464-1468), oxidative stress (Comi, G. P., et al. 1998. Ann. Neurol. 43(1): 110-116), neurofilament abnormalities (Al-Chalabi, A., et al. 1999. Hum. Mol. Genet. 8(2): 157-164; Vechio, J. D., et al. 1996. Ann. Neurol. 40: 603-610), inflammation, growth factors, axonal transport, and other processes (Olkowski, Z. L. 1998. Ann. Neurol. 40: 603-610; Hayward, C., et al. 1999. Neurology 52(9): 1899-1901; Drory, V. E., et al. 2001. J. Neurol. Sci. 190(1-2): 17-20). However, to date, no susceptibility factors have emerged to account for the majority of ALS cases.

There is a tremendous need for a definitive diagnostic test to confirm the diagnosis of Lou Gehrig's disease (ALS) and distinguish it from other ALS-like disorders that display similar symptoms but have different treatment options and prognosis. Clinicians have long sought such a diagnostic test in hopes of providing earlier treatment decisions and improved patient outcomes.

Proteomics is a new field of medical research wherein proteins are identified and linked to biological functions, including roles in a variety of disease states. With the completion of the mapping of the human genome, the identification of unique gene products, or proteins, has increased exponentially. In addition, molecular diagnostic testing for the presence of certain proteins already known to be involved in certain biological functions has progressed from research applications alone to use in disease screening and diagnosis for clinicians. However, proteomic testing for diagnostic purposes remains in its infancy. There is, however, a great deal of interest in using proteomics for the elucidation of potential disease biomarkers.

Detection of abnormalities in the genome of an individual can reveal the risk or potential risk for individuals to develop a disease. The transition from risk to emergence of disease can be characterized as an expression of genomic abnormalities in the proteome. Thus, the appearance of abnormalities in the proteome signals the beginning of the process of cascading effects that can result in the deterioration of the health of the patient. Therefore, detection of proteomic abnormalities at an early stage is desired in order to allow for detection of disease either before it is established or in its earliest stages where treatment may be effective.

Recent progress using a novel form of mass spectrometry called surface enhanced laser desorption and ionization time of flight (SELDI-TOF) for the testing of ovarian cancer and Alzheimer's disease has led to an increased interest in proteomics as a diagnostic tool (Petrocoin, E. F. et al. 2002. Lancet 359:572-577; Lewczuk, P. et al. 2004. Biol. Psychiatry 55:524-530). Furthermore, proteomics has been applied to the study of breast cancer through use of 2D gel electrophoresis and image analysis to study the development and progression of breast carcinoma in patients and in plasma from Alzheimer's disease patients (Kuerer, H. M. et al. 2002. Cancer 95:2276-2282; Ueno, I. et al. 2000. Electrophoresis 21:1832-1845). In the case of breast cancer, breast ductal fluid specimens were used to identify distinct protein expression patterns in bilateral matched pair ductal fluid samples of women with unilateral invasive breast carcinoma.

Detection of biomarkers is an active field of research. For example, U.S. Pat. No. 5,958,785 discloses a biomarker for detecting long-term or chronic alcohol consumption. The biomarker disclosed is a single biomarker and is identified as an alcohol-specific ethanol glycoconjugate. U.S. Pat. No. 6,124,108 discloses a biomarker for mustard chemical injury. The biomarker is a specific protein band detected through gel electrophoresis and the patent describes use of the biomarker to raise protective antibodies or in a kit to identify the presence or absence of the biomarker in individuals who may have been exposed to mustard poisoning. U.S. Pat. No. 6,326,209 B1 discloses measurement of total urinary 17 ketosteroid-sulfates as biomarkers of biological age. U.S. Pat. No. 6,693,177 B1 discloses a process for preparation of a single biomarker specific for O-acetylated sialic acid and useful for diagnosis and outcome monitoring in patients with lymphoblastic leukemia.

Neurodegenerative diseases are difficult to diagnose, particularly in their early stages, as currently there are no biomarkers available for either the early diagnosis or treatment of neuromuscular diseases such as amyotrophic lateral sclerosis (ALS) or ALS-like disorders. There are a number of ALS-like disorders that exhibit similar clinical symptoms as ALS, but have a much better prognosis. Yet the distinction between ALS and ALS-like disorders can be difficult for the physician using current standards of care including medical history, comprehensive physical and neurological examination, MRI, electromyogram, nerve conduction studies, spinal tap for analysis of CSF, a blood test panel, and muscle biopsy.

Thus, there is a continuing need for better ways to detect and distinguish ALS patients from patients having ALS-like disorders.

### SUMMARY OF THE INVENTION

The present invention is a diagnostic assay for differentiating amyotrophic lateral sclerosis (ALS), commonly known as Lou Gehrig's disease, and ALS-like disorders. The method comprises collecting a biological sample from a patient having symptoms consistent with ALS, quantitating up to 34 protein biomarkers identified as related to ALS or ALS-like disorders, and determining whether or not the patient has ALS or an ALS-like disorder based on the statistical analysis of the quantity of the selected protein biomarkers.

One aspect of the present invention is a method for screening a patient for ALS or ALS-like disorders. The method includes: collecting a serum sample from a patient having symptoms consistent with ALS, separating the proteins in the serum sample by 2D gel electrophoresis, quantitating a panel of protein biomarkers, and determining whether or not the patient has a ALS or an ALS-like disorder based on the quantity of those biomarkers in the patient's serum.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the methods for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 a 2D gel electrophoretic image of human serum proteins with 34 biomarkers marked and numbered.

FIG. 2 shows a linear discriminant function analysis of human serum samples from ALS patients and patients with ALS-like disorders.

FIG. 3 shows the performance of the quadratic discriminant function analysis of training and test sets of samples from ALS patients and patients with ALS-like disorders.

### DESCRIPTION OF THE PREFERRED EMBODIMENTS

The present invention is a diagnostic test for differentiating individuals with amyotrophic lateral sclerosis (ALS) patients and patients with ALS-like disorders that express symptoms like ALS. The method is based on the use of 2-dimensional (2D) gel electrophoresis to separate the complex mixture of proteins found in blood serum and the quantitation of a group of identified biomarkers to differentiate patients having ALS from patients having other ALS-like disorders.

In the context of the present invention a “neuromuscular disease” is a condition wherein an individual or patient exhibits a known set of symptoms such as limb weakness, slurred speech, muscle twitching or cramping, and/or swallowing difficulty.

Neuromuscular diseases include, but not be limited to amyotrophic lateral sclerosis (ALS, also known as Lou Gehrig's disease), ALS-like diseases, Parkinson's disease (PD), and PD-like diseases.

In the context of the present invention an “ALS-like disorder” would include six main anatomical categories, as follows:

1. Cervical Spinal Compromise (Myelopathy)
a. Cervical Disc Protrusion
b. Spinal Stenosis
c. Spinal Cord Tumor
d. Primary lateral sclerosis

2. Multiple Sclerosis

3. Lower Motor Neuron Compromise
a. Post Polio Syndrome
b. Spinal Muscular Atrophy

4. Nerve Disease
a. Guillain Barre Syndrome
b. Chronic Inflammatory Demyelinating Polyneuropathy (CIDP)
c. Other Causes of Motor Neuron Compromise
d. Multifocal motor neuropathy

5. Neuromuscular junction compromise
a. Myasthenia Gravis
b. Myasthenic Syndrome (LEMS)
c. Toxins (Black Widow Spider, Botulinum toxin or BOTOX)

6. Muscle Disease
a. Muscular Dystrophy
b. Inclusion Body Myositis (IBM)
c. Polymyositis

In the context of the present invention, the “protein expression profile” corresponds to the steady state level of the various proteins in biological samples that can be expressed quantitatively. These steady state levels are the result of the combination of all the factors that control protein concentration in a biological sample. These factors include but are not limited to: the rates of transcription of the genes encoding the hnRNAs; the rates of processing of the hnRNAs into mRNAs; the splicing variations during the processing of the hnRNAs into mRNAs which govern the relative amounts of the protein isoforms; the rates of processing of the various mRNAs by 3′-polyadenylation and 5′-capping; the rates of transport of the mRNAs to the sites of protein synthesis; the rate of translation of the mRNA's into the corresponding proteins; the rates of protein post-translational modifications, including but not limited to phosphorylation, nitrosylation, methylation, acetylation, glycosylation, poly-ADP-ribosylation, ubiquitinylation, and conjugation with ubiquitin like proteins; the rates of protein turnover via the ubiquitin-proteosome system and via proteolytic processing of the parent protein into various active and inactive subcomponents; the rates of intracellular transport of the proteins among compartments such as but not limited to the nucleus, the lysosomes, golgi, the membrane, and the mitochondrion; the rates of secretion of the proteins into the interstitial space; the rates of secretion related protein processing; and the stability and rates of proteolytic processing and degradation of the proteins in the biological sample before and after the sample is taken from the patient.

In the context of the present invention, a “biomarker” corresponds to a protein present in a biological sample from a patient, wherein the quantity of the biomarker in the biological sample provides information about whether the patient exhibits an altered biological state such as ALS or an ALS-like disorder.

A “control” or “normal” sample is a sample, preferably a serum sample, taken from an individual with no known disease, particularly without a neuromuscular disease.

The method of the present invention is based on the quantification of specified proteins. Preferably the proteins are separated and identified by 2D gel electrophoresis. 2D gel electrophoresis has been used in research laboratories for biomarker discovery since the 1970's (Orrick, L. R. et al. 1973. Proc. Natl. Sci. U.S.A. 70:1316-1320; Goldknopf, I. L. et al. 1975. J. Biol. Chem. 250:71282-7187; O'Farrell, P. et al. 1975. J. Biol. Chem. May 250:4007-4021; Anderson, L. and Anderson, N. G. 1977. Proc. Natl. Acad. Sci. U.S.A. 74:5421-5425; Goldknopf, I. L. and Busch, H. 1977. Proc. Natl. Acad. Sci. USA 74:864-868). In the past, this method has been considered highly specialized, labor intensive and non-reproducible.

Only recently with the advent of integrated supplies, robotics, and software combined with bioinformatics has progression of this proteomics technique in the direction of diagnostics become feasible. The promise and utility of 2D gel electrophoresis is based on its ability to detect changes in protein expression and to discriminate protein isoforms that arise due to variations in amino acid sequence and/or post-synthetic protein modifications such as phosphorylation, nitrosylation, ubiquitination, conjugation with ubiquitin-like proteins, acetylation, and glycosylation. These are important variables in cell regulatory processes involved in disease states.

There are few comparable alternatives to 2D gels for tracking changes in protein expression patterns related to disease progression. The introduction of high sensitivity fluorescent staining, digital image processing and computerized image analysis has greatly amplified and simplified the detection of unique species and the quantification of proteins. By using known protein standards as landmarks within each gel run, computerized analysis can detect unique differences in protein expression and modifications between two samples from the same individual or between several individuals.

### Sample Collection and Preparation

Serum samples were prepared from blood acquired by venipuncture. The blood was centrifuged at 500×g for 10 minutes, and the separated serum was divided into aliquots, and frozen at −40° C. or below until shipment. Samples were shipped on dry ice and were delivered within 24 hours of shipping.

Once the serum samples were received, logged in, and assigned a sample number, they were further processed in preparation for 2D gel electrophoresis. All samples were stored at −40° C. or below. When the serum samples were removed from storage, they were placed on ice for thawing and kept on ice for further processing.

To each 100 μl of sample, 100 μl of LB-2 buffer (5M urea, 2M Thiourea, 0.5% ASB-14, 0.25% CHAPS, 0.25% Tween-20, 5% glycerol, 100 mM DTT, 1× Protease inhibitors, and 1× Ampholyte pH 3-10) was added and the mixture vortexed. The sample was incubated at room temperature for about 5 minutes.

### Separation of Proteins in Patient Samples

The proteins in the patient and control samples were separated using various techniques known in the art for separating proteins, techniques that include but are not limited to gel filtration chromatography, ion exchange chromatography, reverse phase chromatography, affinity chromatography, or any of the various centrifugation techniques well known in the art. In some cases, a combination of one or more chromatography or centrifugation steps may be combined via electrospray or nanospray with mass spectroscopy or tandem mass spectroscopy, or any protein separation technique that determines the pattern of proteins in a mixture either as a one-dimensional, two-dimensional, three-dimensional or multi-dimensional pattern or list of proteins present.

### Two Dimensional-Electrophoresis of Samples

Preferably the protein profiles of the present invention are obtained by subjecting biological samples to two-dimensional (2D) gel electrophoresis to separate the proteins in the biological sample into a two-dimensional array of protein spots.

Two-dimensional gel electrophoresis is a useful technique for separating complex mixtures of proteins and can be performed using a variety of methods known in the art (see, e.g., U.S. Pat. Nos. 5,534,121; 6,398,933; and 6,855,554).

Preferably, the first dimensional gel is an isoelectric focusing gel and the second dimension gel is a denaturing polyacrylamide gradient gel.

Proteins are amphoteric, containing both positive and negative charges and like all ampholytes exhibit the property that their charge depends on pH. At low pH (acidic conditions), proteins are positively charged while at high pH (basic conditions) they are negatively charged. For every protein there is a pH at which the protein is uncharged, the protein's isoelectric point. When a charged molecule is placed in an electric field it will migrate towards the opposite charge.

In a pH gradient such as those used in the present invention, a protein will migrate to the point at which it reaches its isoelectric point and becomes uncharged. The uncharged protein will not migrate further and stops. Each protein will stop at its isoelectric point and the proteins can thus be separated according to charge. In order to achieve optimal separation of proteins, various pH gradients may be used. For example, a very broad range of pH, from about 3 to 11 or 3 to 10 can be used, or a more narrow range, such as from pH 4 to 7 or 7 to 10 or 6 to 11 can be used. The choice of pH range is determined empirically and such determinations are within the skill of the ordinary practitioner and can be accomplished without undue experimentation.

In the second dimension, proteins are separated according to molecular weight by measuring mobility through a polyacrylamide gradient in the detergent sodium dodecyl sulfate (SDS). In the presence of SDS and a reducing agent such as dithiothreitol (DTT), the proteins act as though they are of uniform shape with the same charge to mass ratio. When the proteins are placed in an electric field, they migrate into and through the gel from one edge to the other. As the proteins migrate though the gel, individual proteins move at different speeds with the smaller ones moving faster than the larger ones. This process is stopped when the fastest moving components reach the other side of the gel. At this point, the proteins are distributed across the gel with the higher molecular weight proteins near the origin and the low molecular weight proteins near the other side of the gel.

It is well known in the art that various concentration gradients of acrylamide may be used for such protein separations. For example, a gradient of from about 5% to 20% may be used in certain embodiments or any other gradient that achieves a satisfactory separation of proteins in the sample may be used. Other gradients would include but not be limited to from about 5 to 18%, 6 to 20%, 8 to 20%, 8 to 18%, 8 to 16%, 10 to 16%, or any range as determined by one of skill.

The end result of the 2D gel procedure is the separation of a complex mixture of proteins into a two dimensional array based on their unique characteristics of isoelectric point and molecular weight

### 2D SDS-PAGE Standards

Purified proteins having known characteristics are used as internal and external standards and as a calibrator for 2D gel electrophoresis. The standards consist of seven reduced, denatured proteins that can be run either as spiked internal standards or as external standards to test the ampholyte mixture and the reproducibility of the gels. A set mixture of proteins (the “standard mixture”) is used to determine pH gradients and molecular weights for the two dimensions of the electrophoresis operation. Table 1 lists the isoelectric point (pI) values and molecular weights for the proteins included in this standard mixture.

TABLE 1

| | | Molecular |
|---|---|---|
| Protein | pI | Weight (Da) |
| Hen egg white conalbumin | 6.0, 6.3, 6.6 | 76,000 |
| Bovine serum albumin | 5.4, 5.5, 5.6 | 66,200 |
| Bovine muscle actin | 5.0, 5.1 | 43,000 |
| Rabbit muscle GAPDH | 8.3, 8.5 | 36,000 |
| Bovine carbonic anhydrase | 5.9, 6.0 | 31,000 |
| Soybean trypsin inhibitor | 4.5 | 21,500 |
| Equine myoglobin conalbumin | 7.0 | 17,500 |

In addition, Precision Plus Protein Standards (Bio-Rad Laboratories), a mixture of 10 recombinant proteins ranging from 10-250 kD, are typically added as external molecular weight standards for the second dimension, or the SDS-PAGE portion of the system. The Precision Plus Protein Standards have an r² value of the R_{f} vs. log molecular weight plot of >0.99.

### Separation of Proteins in Serum Samples

An appropriate amount of isoelectric focusing (IEF) loading buffer (LB-2), was added to the diluted serum sample, incubated at room temperature and vortexed periodically until the pellet was dissolved to visual clarity. The samples were centrifuged briefly before a protein assay was performed on the sample.

Approximately 100 μg of the solubilized protein pellet was suspended in a total volume of 184 μl of IEF loading buffer and 1 μl Bromophenol Blue. Each sample was loaded onto an 11 cm IEF strip (Bio-Rad Laboratories), pH 5-8, and overlaid with 1.5-3.0 ml of mineral oil to minimize the sample buffer evaporation. Using the PROTEAN® IEF Cell, an active rehydration was performed at 50V and 20° C. for 12-18 hours.

IEF strips were then transferred to a new tray and focused for 20 min at 250V followed by a linear voltage increase to 8000V over 2.5 hours. A final rapid focusing was performed at 8000V until 20,000 volt-hours were achieved. Running the IEF strip at 500V until the strips were removed finished the isoelectric focusing process.

Isoelectric focused strips were incubated on an orbital shaker for 15 min with equilibration buffer (2.5 ml buffer/strip). The equilibration buffer contained 6M urea, 2% SDS, 0.375M HCl, and 20% glycerol, as well as freshly added DTT to a final concentration of 30 mg/ml. An additional 15 min incubation of the IEF strips in the equilibration buffer was performed as before, except freshly added iodoacetamide (C₂H₄INO) was added to a final concentration of 40 mg/ml. The IPG strips were then removed from the tray using clean forceps and washed five times in a graduated cylinder containing the Bio Rad Laboratories running buffer 1× Tris-Glycine-SDS.

The washed IEF strips were then laid on the surface of Bio Rad pre-cast CRITERION SDS-gels 8-16%. The IEF strips were fixed in place on the gels by applying a low melting agarose. A second dimensional separation was applied at 200V for about one hour. After running, the gels were carefully removed and placed in a clean tray and washed twice for 20 minutes in 100 ml of pre-staining solution containing 10% methanol and 7% acetic acid.

### Staining and Analysis of the 2D Gels

Once the 2D gel patterns of the serum samples were obtained, the gels were visualized with either a fluorescent or colored stain. SyproRuby™ (Bio-Rad Laboratories) was the preferred stain. Once the protein spots had been stained, the gel was scanned and a digital image of the protein expression profile of the sample was obtained.

The digital image of the scanned gel was processed using PDQuest™ (Bio-Rad Laboratories) image analysis software to first locate the selected biomarkers and then to quantitate the protein in each of the selected spots. The scanned image was cropped and filtered to eliminate artifacts using the image editing control. Individual cropped and filtered images were then placed in a matched set for comparison to other images and controls.

This process allowed quantitative and qualitative spot comparisons across gels and the determination of protein biomarker molecular weight and isoelectric point values. Multiple gel images were normalized to allow an accurate and reproducible comparison of spot quantities across two or more gels. The gels were normalized using the “total of all valid spots method” which assumes that few protein spots change between serum samples, and that changes average out across the whole gel. The quantitative amount of the selected biomarkers present in each sample was then exported for further analysis using statistical programs.

### Initial Biomarker Selection

The 2D gel patterns of 92 serum samples collected from normal control subjects were compared with each other. The 92 normal samples all gave similar 2D gel protein patterns. The normal protein expression pattern was then compared to the gel patterns obtained in serum samples of 183 patients diagnosed with a neuromuscular disease. The comparison of the protein expression pattern of normals and neuromuscular patients identified at least 34 protein spots seen on 2D gels that differed in protein concentration.

Once the 92 normal serum samples and the 183 neuromuscular disease serum samples had been run on 2D gels and the initial 34 identified protein spots were quantitated in each serum sample, the results were analyzed using statistical programs to determine which biomarkers to include in the assay for ALS in order for the assay to have a sensitivity, specificity, and positive and negative predictive values to be of clinical use to physicians.

Initially, the mean and standard deviations of the biomarkers were used to select the biomarkers and to assess the statistical significance of concentration differences in the biomarkers between the control sera and the neuromuscular disease sera. However because of the number of biomarkers studied, subsequent studies used multi-variant statistical programs to select the biomarkers. A linear discriminate functional analysis was initially employed to determine the sensitivity, specificity, positive predictive value (PPV), and negative predictive value (NPV) of each biomarker and a number of combinations of biomarkers in determining the difference between normal serum and serum taken from patients diagnosed with neuromuscular disease. However, the analysis of the training set and test sets of ALS patient samples have shown the quadratic discriminant analysis of the data sets to be superior to the use of linear discriminant analysis. Therefore, even though a linear discriminant analysis would be included as an embodiment of the present invention, the preferred embodiment of the present invention uses a quadratic discriminant analysis of the data. Both linear and quadratic discriminant analyses are further described below.

### Biostatistical Discriminant Function

The quantitative amount of the selected biomarkers present in each sample was then analyzed using a biostatistical discriminant function. The concentrations for the set of selected biomarkers were entered into a biostatistical algorithm and the sample was classified as either ALS or as an ALS-like disorder based on a comparison to a database of values collected from the individuals in the training set from which the discriminant function was derived.

The output of discriminant analysis is a classification table that permits the calculation of clinical sensitivity, specificity, positive predictive value (PPV) and negative predictive value (NPV). These terms are defined herein as follows: (1) the clinical sensitivity measured how often the test yielded positive results in diseased patients, in the case of the present invention, patients with ALS; (2) the clinical specificity measured how often the test gave negative results in non-diseased individuals, in this case patients with ALS-like disorders; (3) the negative predictive value (NPA) measured the probability that the patient would not have the disease and therefore have an ALS-like disorder when values were restricted to all individuals who tested negative; and (4) the positive predictive value (PPV) measured the probability that the patient had the disease (i.e., ALS) when values were restricted to those individuals who tested positive.

A standard discriminant function analysis was performed to determine the subset of biomarkers that would be most useful in differentiating individuals with ALS from those individuals with ALS-like disorders. Discriminant analysis has been well-validated as a multivariate analysis procedure. Discriminant analysis identified sets of linearly independent functions that successfully classify individuals into a well-defined collection of groups. The statistical model used assumed a multivariate normal distribution for the set of biomarkers identified from each disease group.

Where xᵢⱼ represented the p-tuple vector of biomarkers from the i^{th} patient in the j^{th} group, j=1, and [symbol] represented the p-tuple centroid of the j^{th} group, made up of the mean biomarker values from the jth disease group, then S represented the estimate of the within group variance-covariance matrix. The discriminant function was then that set of linear functions determined by the vector a that maximizes the quantity:

$$\frac{{n}_{1} + {n}_{2}}{{n}_{1} {n}_{2}} \frac{{[ \underline{{a}^{′}} ( {\overline{x}}_{1} - {\overline{x}}_{2} ) ]}^{2}}{{\underline{a}}^{′} S \underline{a}}$$

The outcome of the discriminant analysis was a collection of m−1 linear functions of the biomarkers (m) that maximized the ability to separate individuals into disease groups. The vector α is the p-tuple vector which contained the coefficients that, when multiplied by an individual's biomarkers, produced the linear discriminant function, or index that was used to classify that individual. In general, if m biomarkers are used, a maximum of (m−1, g−1) discriminant functions are determined where g represented the number of groups.

Where aⱼ(k) represented the k^{th} p-tuple discriminant function. Then the value of that discriminator for the i^{th} patient is aⱼ(k)′xᵢ. Thus for each patient there are k such values computed, which are used in a classification analysis. The discriminant functions themselves are linearly independent (i.e., for each pair of the m discriminant functions) aⱼ(k) and aⱼ(l), then aⱼ(k)′aⱼ(l)=0. Thus, the m−1 discriminant functions provide incremental and non-redundant discriminant ability.

Identifying the discriminant function involved identifying the coefficients λ from the linear algebraic system of equations |H−λᵢ(H+E)|=0 where H and E were the one way analysis of variance hypotheses and error matrices respectively. It is this computation that was provided by SAS™ statistical software. The SAS software program identified the collection of best discriminators using a forward entry procedure where the p-value to enter and the p-value to stay in the model are each 0.15.

While the discrimination procedure was fairly robust in the presence of mild departures from the normality assumption, it was very sensitive to the assumption of homogeneity of variance. This means that the variance-covariance matrices of the groups between which discrimination was sought must be equal. In this circumstance, these variance-covariance matrices can be pooled. However, in the situation where the variance-covariance matrices are not equal (multivariate heteroscedasticity), this pooling procedure is suboptimal. In this circumstance, the individual variance-covariance matrices have been used.

The use of the two within-group variance-covariance matrices is an important complication in the computation of discriminant functions. When the homoscedasticity assumption is appropriate, the within group variance-covariance matrices can be pooled, producing a linear discriminant function. The use of the within-group variance-covariance matrices produced a quadratic discriminant function (i.e., where the discriminant function is a function of the squares of the proteomic measures).

### Classification Analysis

Individuals with either a prior diagnosis of ALS or ALS-like disorders were randomly allocated using a 4:1 ratio into either a training set or a test set. Disease classifications were based on clinical symptoms and family history.

Discriminant analysis was applied to the training set, from which the contribution of each individual biomarker was determined. The SAS™ statistical software program was then used to determine the linear combinations of biomarkers that provided an optimum classification of individuals into disease groups. Alternatively, the programmer can manually select different combinations of biomarkers to be incorporated into a quadratic discriminant function to optimize the classification of individuals into disease groups. Once an individual discriminant model was “trained” by optimizing performance using a representative set of samples (the “training set”), the same set of discriminators were then used to classify an independent set of individuals (the “test set”). Thus, the test set was used to examine the validity of identifying individuals with ALS from those with ALS-like disorders using the selected biomarkers. The test set consisted of ALS patient samples only, as there were an insufficient number of ALS-like patient samples to adequately construct independent training and test sets of the ALS-like disorders.

Thirty-four protein biomarkers were identified in the training set that both individually and/or jointly discriminated ALS patient samples from samples taken from patients with ALS-like disorders. Various sets of biomarkers (representing one, multiple or all thirty-four biomarkers) were then used to analyze the training set and then the test data set, using the same discriminant functions built against the training data set to determine the ability of each set of biomarkers to predict ALS. Individuals were classified as ALS or having ALS-like disorders based on clinical symptoms and family history. Each of the 34 protein biomarkers were assessed individually through discriminant analysis to determine its ability to predict ALS.

### 2D Gel Electrophoretic Controls

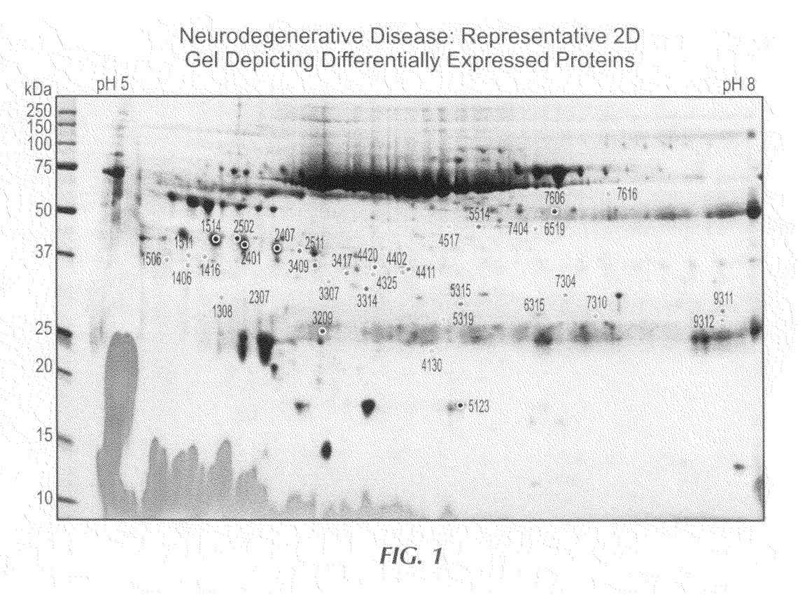

Representative samples from individuals with known cases of ALS and ALS-like disorders were run as positive and negative reference controls. Serum containing all of the selected biomarkers was also provided as a reference standard. A reference control was periodically run as an external standard and for tracking overall performance and reproducibility. In addition, 2D gel images from samples classified as ALS and ALS-like disorders were used for reference. The spot locations were noted for the selected biomarkers, as well as for landmark proteins commonly found in human serum (see FIG. 1).

### The Reproducibility of Biomarker Identification and Quantification

The consistency and reproducibility of quantifying biomarkers using 2D-gel electrophoresis was characterized. To optimize reproducibility, each sample was preferably run in triplicate and each set of replicate samples was analyzed as a group. This maximized the overall accuracy of spot identification and biomarker quantification. The average percent Co-efficient of Variation (% CV) is 11±7% for 10 biomarkers quantified from a single image scanned 10 times. The average % CV is 23% for a set of 25 biomarkers quantified from 12 separate processed aliquots of the same sample. The range in biomarker concentrations for this group of biomarkers ranged from a low of 248 ppm to a high of 15,548 ppm normalized concentration of spot per total detected spots in the 2D gel.

The protein concentrations employed in the discriminant function were relative values obtained by normalizing the intensity of each spot to all detected spots in the image. The linear range in protein concentrations was 0.5 to 1,000 ng per spot. The concentration of any given spot was the absolute amount of protein in that spot divided by the total protein loaded onto the gel. The total amount of protein loaded onto a gel was typically about 100 μg.

Serum is primarily comprised of a highly conserved distribution of the most abundant proteins, such as albumin and immunoglobulin, which enhance efforts to ensure the reproducibility and consistency of biomarker detection and quantitation. The selected biomarkers represented a minor fraction of the total serum protein. Therefore the concentration of the selected biomarkers varied significantly as a function of disease state without significantly shifting the overall distribution and concentration of the major serum proteins. Discriminant biostatistics were employed to establish the dynamic concentration range of the selected biomarkers useful in differentiating ALS patients.

### Biomarker Stability

The effect of multiple freeze/thaw cycles on protein stability and sample integrity was investigated. A serum sample was collected and aliquoted. One aliquot was processed without freezing, while other aliquots were frozen at −80° C. and thawed repetitively. A second set of serum samples was diluted into loading buffer and aliquoted. The second set of samples, similar to the first set, had one aliquot processed without freezing and other aliquots frozen at −80° C. and thawed repetitively.

Triplicate samples were processed as described. The scanned images of the 2D gels were analyzed, and the quantities of each of the 34 neurodegenerative biomarkers of interest were determined. The results illustrated that freezing and thawing either undiluted or diluted serum samples up to 10 times had no significant effect on the serum protein profile or on the abundance of the selected biomarkers.

In addition, sample deterioration was investigated over a one-year period. Twenty-one selected biomarkers were quantitated in control samples stored at −80° C. An aliquot of each control sample was processed several times each quarter, or each 3 month time period. The results demonstrated that there was no significant increase or decrease in the quantity of biomarker detected over a one-year time frame for samples stored at −80° C., beyond that which is typically observed for processing replicate samples.

### Samples Analyzed

Serum samples were obtained from 136 ALS patients and 31 patients having ALS-like disorders. All individuals with symptoms of a neuromuscular disorder were evaluated and diagnosed by a neurologist. All individuals diagnosed with ALS were classified as Probable or Definite ALS by the revised El Escorial criteria (Brooks, B. R., et al. 2000. Amyotroph. Lateral Scler. Other Motor Neuron Disord. 1(5):293-9).

The ALS-like disorder controls included individuals with the following conditions: Benign Fasciculations, Brachial Amyotrophic Diplegia, Brachial Plexopathy, Cervical Myelopathy, Lumbosacral Radiculopathy, Cervical Radiculopathy, Chronic Inflammatory Demyelinating Polyradiculoneuropathy (CIDP), Corticalbasal Ganglionic Degeneration (CBGD), Diabetic Neuropathy, Cervical and Lumbar Stenosis, Guillain Barre Syndrome—Axonal type, Inclusion Body Myositis (IBM), Idiopathic Sensory Ataxia, Inflammatory Peripheral Neuropathy, Lewy Body Dementia, Inflammatory Myelopathy with Polyneuropathy, Monomelic Amyotrophy, Multiple Sclerosis, Muscle Spasms, Muscular Dystrophy, Myasthenia Gravis, Myotonic Dystrophy, Progressive Bulbar Palsy, Multiple System Atrophy, Multiple System Atrophy with Subdural Hematoma, Progressive Muscular Atrophy, Spinal Bulbar Muscular Atrophy (Kennedy's disease), Spinal Muscular Atrophy (SMA), Spinal Cord Syrinx with history of Spinal Meningitis, and Vascular Parkinsonism.

Ninety of the 136 ALS samples were randomly selected for use in the training set for constructing the discriminant function. All 31 of the ALS-like disorder samples were used in the training set due to an insufficient number of patients in this group. Thus, the training set contained 90 ALS patient samples and 31 samples from patients having ALS-like disorders. Once the discriminant function was developed, the remaining ALS samples were used in a validation set.

### Differentiating ALS and ALS-Like Disorders

The preferred embodiment used all 34 biomarkers of interest. To assay patient samples based on all 34 biomarkers the training set used in training the discriminant function included all 34 biomarkers. Although a variety of different combinations of biomarkers were also tested that gave comparable statistical performance, they are not specifically described herein but would be performed in a similar fashion.

As shown in FIG. 1, the 34 biomarkers were resolved by 2D gel electrophoresis of human serum proteins. The proteins were visualized by the sensitive (≦1 ng protein/spot out of 100 μg serum proteins per gel) and linearly staining (linearity and dynamic range of from ≦1 ng to ≧1000 ng) SyproRuby™ fluorescent stain. The stained gels were scanned and the digital image of the 2D gel was analyzed using PDQuest™ quantitative digital image analysis software.

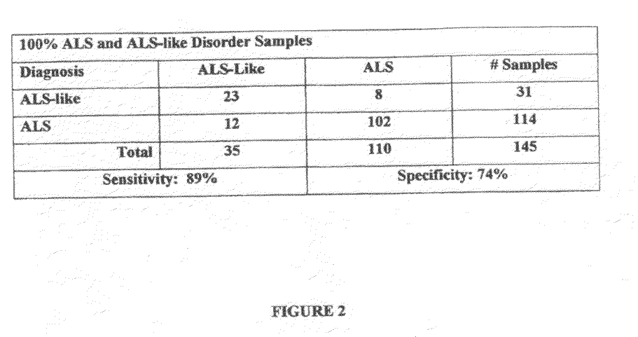

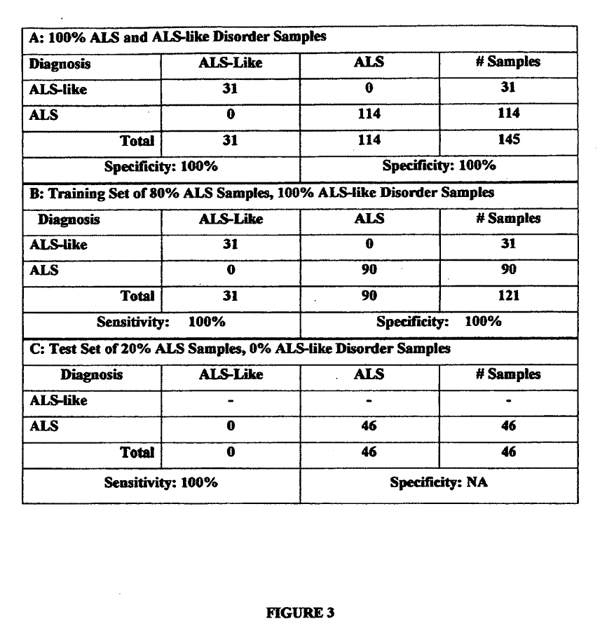

The quantitative results were then subjected to linear and quadratic discriminant analysis using the SAS™ statistical software. The results, shown in FIGS. 2 and 3, indicated that the quadratic discriminant analysis was superior to the linear discriminant analysis. The linear discriminant analysis only correctly classified 23 of the 31 patient samples from ALS-like disorders (74% specificity) and only 102 of the 114 ALS patient samples (89% sensitivity). Although these results could be clinically useful, use of the quadratic discriminant analysis properly classified all 31 of the patient samples from ALS-like disorders (100% specificity) and all 114 ALS patient samples correctly (100% sensitivity). Thus, the quadratic discriminant analysis was selected as the preferred embodiment.

When a randomized 80% training set (ALS+ALS like) and a test set (independent samples of ALS+duplicate and replicate ALS sample data, not included in the training set) validation was performed using quadratic discriminant analysis (see FIG. 3), the performance was perfect for these samples (i.e., 100% specificity and 100% sensitivity).

When samples from ALS-like disorders that were not included in the training set were used in a test set, a few of those samples were misidentified as ALS. Inasmuch as the ALS-like patients represent a large group of diseases with similar symptoms but somewhat different anatomical and biological features, it was postulated that the 31 samples of ALS-like serum did not provide a sufficiently representative and robust model for the ALS-like classification. Thus, a larger number of ALS-like disorder samples in both the training and validation sets will be acquired, analyzed and added to the training and test datasets.

Assay for ALS vs. ALS-Like Disorders

Definitive diagnostic tests to confirm the diagnosis of Lou Gehrig's disease (ALS) and distinguish it from the ALS-like disorders that display similar symptoms but have different treatment options and prognosis have long been sought by clinicians in hopes of providing earlier treatment decisions and improved patient outcomes. ALS is a devastating, fatal neurodegenerative disease that causes the progressive loss of the cells in the brain, spinal cord, and motor nerves that control muscle function. It is the third most common neurodegenerative disease in adults, after Alzheimer's disease and Parkinson's disease. Early symptoms of ALS may include arm and leg weakness, stiffness, and slurred speech. The majority of patients die within 3-5 years from first symptom, usually from respiratory muscle failure.

Presently, the diagnosis of ALS is a clinical one. There is no test that provides diagnostic certainty. The usual diagnostic process consists of a full medical history, and comprehensive physical and neurological examinations. The revised El Escorial Criteria, developed at a Consensus Conference in Spain in 1990, is widely accepted for the diagnosis of ALS (Chaudhuri, K. R., et al. 1995. J. Neurol. Sci. 129 Suppl.: 11-12). This set of criteria combines clinical features and laboratory test findings to classify the level of diagnostic certainty into Definite, Probable, Possible, and Suspected.

As mentioned previously, no definitive diagnostic test for ALS is currently available. Numerous studies are generally performed to rule out other medical conditions that can mimic the appearance of ALS. This is important because many of the ALS-like conditions have a much more favorable prognosis. A complete evaluation may include an electromyogram (EMG) with nerve conduction studies (NCV), magnetic resonance imaging (MRI) of the brain and spinal cord, lumbar puncture (LP) with analysis of cerebrospinal fluid (CSF), a panel of blood tests, and muscle biopsy. Because the El Escorial criteria set was originally designed for research purposes, some clinicians find them to be somewhat cumbersome (Brooks, B. R. 2000. Amyotroph. Lateral. Scler. Other Motor Neuron Disord. Suppl 1:S79-S81).

The etiology of ALS is undefined and it is unclear what places a person at-risk of getting ALS. A combination of genetic susceptibility factors and environmental factors is thought to be involved. Researchers have searched for genetic susceptibility factors that affect cellular processes that influence the survival of motor neurons; however, to date, no susceptibility factor has emerged to account for the majority of ALS cases.

In summary, the diagnosis of ALS is currently based on clinical criteria and the results of electrodiagnostic studies. Numerous neuroimaging and blood studies are generally performed, mostly to rule out the presence of other medical conditions that may mimic the clinical appearance of ALS. To date no definite biochemical or genetic test is available to definitively diagnose ALS, or to differentiate ALS from ALS-like conditions.

The present invention provides an assay for differentiating ALS from ALS-like disorders. The assay is comprised of the following steps: (1) collecting a serum sample from a patient; (2) running triplicate 2D gel electrophoreses of the patient sample; (3) staining the 2D gel; (4) creating a digital image of the 2D gel; (5) quantifying the protein concentration in selected protein spots on the 2D gel; and (6) performing a statistical analysis on the quantity of the selected proteins to determine the likelihood of the patient having ALS or an ALS-like disorder.

While the methods have been described in terms of preferred embodiments, it will be apparent to those of skill in the art that variations may be applied to the methods including the sequence of steps in the methods. Certain agents may be substituted by one of skill and similar results may be achieved, as will be appreciated by one of skill in the art. Such modifications or substitutions to the methods of the present invention are deemed to be within the spirit, scope and concept of the invention as defined by the disclosure and its claims.

What is claimed is:

1. A process for selecting appropriate biomarkers useful in diagnosis of ALS comprising:
a) collecting serum samples from patients diagnosed with ALS;
b) collecting serum samples from patients diagnosed with an ALS-like disorder;
c) performing a two-dimensional gel electrophoretic analysis of each ALS and ALS-like serum samples;
d) staining each two-dimensional gel;
e) quantitating a protein concentration in a plurality of protein spots on the two-dimensional gel; and
f) performing a discriminant statistical analysis on the quantities of the proteins in the protein spots from the ALS serum samples and the ALS-like serum samples to select a plurality of biomarker spots to distinguish between patients with ALS from patients with the ALS-like disorder.

2. The process of claim 1, wherein the protein concentration in the protein spots was quantitated using a digital image of the two-dimensional gel.

3. The process of claim 1, wherein the discriminant statistical analysis is a linear discriminant analysis.

4. The process of claim 1, wherein the selected biomarker spots distinguished between patients with ALS from patients with the ALS-like disorder with at least 89% sensitivity and 74% specificity.

5. The process of claim 1, wherein the discriminant statistical analysis is a quadratic discriminant analysis.

6. The process of claim 1, wherein each two-dimensional gel was stained with a fluorescent stain.

7. The process of claim 6, wherein the fluorescent stain visualized protein spots containing at least 1 nanogram of protein on two-dimensional gels loaded with about 100 micrograms of protein.

8. A screening assay for ALS comprising:
a) collecting a serum sample from a patient;
b) performing a two-dimensional (2D) gel electrophoretic analysis of the serum sample;
c) staining the 2D gel pattern;
d) quantitating a concentration of protein in each of a plurality of preselected protein spots; and
e) performing a discriminant statistical analysis on the quantity of protein in the selected spots to determine the likelihood of the patient having ALS or an ALS-like disorder.

9. The screening assay of claim 8, wherein the plurality of preselected protein spots includes a set of 34 biomarkers.

10. The screening assay of claim 8, wherein the protein concentration in the protein spots was quantitated using a digital image of the two-dimensional gel.

11. The screening assay of claim 8, wherein the discriminant statistical analysis is a linear discriminant analysis.

12. The screening assay of claim 8, wherein the selected biomarker spots distinguished between patients with ALS from patients with the ALS-like disorder with at least 89% sensitivity and 74% specificity.

13. The screening assay of claim 8, wherein the discriminant statistical analysis is a quadratic discriminant analysis.

14. The screening assay of claim 8, wherein each two-dimensional gel was stained with a fluorescent stain.

15. The screening assay of claim 8, wherein the fluorescent stain visualized protein spots containing at least 1 nanogram of protein on two-dimensional gels loaded with about 100 micrograms of protein.

16. A screening assay for ALS comprising:
a) collecting a serum sample from a patient;
b) performing a two-dimensional (2D) gel electrophoretic analysis of the serum sample;
c) staining the 2D gel pattern;
d) quantitating a concentration of protein in each of a plurality of a set of preselected protein spots using a digital image of the 2D gel; and
e) performing a discriminant statistical analysis to compare the quantity of protein in the set of preselected protein spots of the patient sample with the quantity of protein in the same set of preselected spots in a set of patient samples having ALS and a set of patient samples having an ALS-like disorder.

17. The assay of claim 16, wherein the set of preselected protein spots includes a set of 34 biomarkers.

18. The assay of claim 17, wherein the discriminant statistical analysis is a linear discriminant analysis distinguishing between patients with ALS and patients with an ALS-like disorder with at least 89% sensitivity and 74% specificity.

19. The assay of claim 17, wherein the discriminant statistical analysis is a quadratic discriminant analysis.

20. A method for diagnosing a patient with ALS comprising the steps of:
a) collecting a serum sample from a patient;
b) performing a two-dimensional (2D) gel electrophoretic analysis of the serum sample;
c) staining the 2D gel pattern with a fluorescent stain that visualizes protein spots containing at least 1 nanogram of protein in a 2D gel leaded with about 100 micrograms of protein;
d) quantitating a concentration of protein in each of a plurality of a set of preselected protein spots using a digital image of the 2D gel; and
e) performing a quadratic discriminant statistical analysis to compare the quantity of protein in the set of selected protein spots of the patient sample with the quantity of protein in the same set of selected spots in serum samples from a set of patients diagnosed with ALS and in serum samples from a set of patients diagnosed with an ALS-like disorder.
